(19) United States
(12) Patent Application Publication
(10) Pub. No.: US 2007/0198921 A1
(43) Pub. Date: Aug. 23, 2007

(54) Facilitating manual user selection of one or more ads for insertion into a document to be made available to another user or users

(76) Inventors: Derek Collison, Atherton, CA (US); Mark Lucovsky, Montecito, CA (US); Carl Sjogreen, San Francisco, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/443,479

(22) Filed: May 30, 2006

Related U.S. Application Data
(63) Continuation-in-part of application No. 11/366,466, filed on Mar. 3, 2006.
(60) Provisional application No. 60/774,198, filed on Feb. 17, 2006.

(51) Int. Cl. G06F 17/00; G06F 15/00

(52) U.S. Cl. 715/517

(57) ABSTRACT

User distributed advertisements (UDA ads) facilitates insertion of manually selected ads into a document that is to be distributed (e.g., transmitted, published, and/or posted) such that the document is to be made available to other users. For example, manually selected ads can be inserted into an email to be sent to another user, a blog to be posted for viewing by other users, a message to be sent to another user, a message board entry to be posted for viewing by other users, a document published and made available to other users, etc. Hence, UDA ads provide a scaleable advertising platform that achieves at least some of the benefits of manual targeting. Charges might be assessed to the advertiser, perhaps subject to one or more conditions being met. Rewards might be provided to the user that inserts and/or distributes the UDA ad, perhaps subject to one or more conditions being met. Performance metrics of UDA ads might be determined and used for various purposes, such as later ad serving arbitrations. A user interface for advertisers to allow their ads to be UDA ad-enabled might be provided.

### § 0. RELATED APPLICATIONS

This application is a continuation-in-part of U.S. patent application Ser. No. 11/366,466 (referred to as “the '466 application” and incorporated herein by reference), titled “User Distributed Search Results”, filed on Mar. 3, 2006, and listing Mark Lucovsky, Derek Collison, and Carl Sjogreen as inventors, which claims the benefit of the filing date of Provisional Patent Application Ser. No. 60/774,198 (referred to as “the '198 provisional” and incorporated herein by reference), filed on Feb. 17, 2006.

### § 1. BACKGROUND OF THE INVENTION

§ 1.1 Field of the Invention

The present invention concerns advertising, such as online advertising for example. In particular, the present invention concerns providing a platform to enable users to manually select one or more ads for insertion into a document that is to be made available to others, as well as related technologies.

§ 1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif. (referred to as “Google”), delivers ads targeted to keywords from search queries. Similarly, content targeted ad delivery systems have been proposed. For example, U.S. patent application Ser. No. 10/314,427 (incorporated herein, in its entirety, by reference and referred to as “the '427 application”), titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated herein, in its entirety, by reference and referred to as “the '900 application”), titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

Although advertising systems such as AdWords and AdSense have proven to be very effective tools for advertisers to reach a receptive audience, even automated systems that use sophisticated targeting techniques often can't match the effectiveness of manual targeting. However, manual targeting techniques don't scale well. Therefore, it would be useful to provide a scaleable advertising system that achieves at least some of the benefits of manual targeting. It would also be useful to provide a system of charges and/or rewards to encourage useful manual targeting of ads. Further, it would also be useful to track and use performance metrics of such ads if doing so would help an advertising system serve ads that are more useful. Finally, it would be useful to provide data structures and interfaces for enabling advertisers to participate in a system for manual insertion of ads into a document for distribution.

### § 2. SUMMARY OF THE INVENTION

Embodiments consistent with the present invention may facilitate the manual selection of one or more ads for insertion into a document, as well as transmission, posting, publication, or other distribution of the document including the ads. At least some such embodiments might (a) render a set of one or more ads to a first user, wherein each of the one or more ads includes a user selectable insertion element, (b) accept a selection input from the first user on the user selectable insertion element of one of the one or more ads, and (c) provide an instance of the one ad in a document. Some embodiment consistent with the present invention might further accept an input from the first user for making the document available to a second user.

### § 3. BRIEF DESCRIPTION OF THE DRAWINGS

FIG. 1 is a bubble diagram of exemplary operations that may be performed in a manner consistent with the present invention, as well as information that may be used and/or generated by such operations.

FIG. 2 is a flow diagram of an exemplary method for facilitating the manual distribution of one or more ads, as well as providing various incentives related to such ad(s), in a manner consistent with the present invention.

FIG. 3 is a block diagram of apparatus that may be used to perform at least some operations, and store at least some information, in a manner consistent with the present invention.

FIG. 4 is an exemplary architecture consistent with the present invention within an exemplary operating environment.

FIGS. 5A and 5B illustrate an exemplary embodiment consistent with the present invention applied in the context of email.

FIG. 6 illustrates an exemplary embodiment consistent with the present invention applied in the context of Web message board postings.

FIG. 7 illustrates an exemplary embodiment consistent with the present invention applied in the context of instant messaging.

FIG. 8 illustrates an exemplary embodiment consistent with the present invention applied in the context of blog entries.

FIG. 9 illustrates an exemplary advertisement, consistent with the present invention, which includes a selectable insertion element.

FIG. 10 is a bubble diagram of exemplary operations that may be performed in a manner consistent with the present invention, as well as information that may be used and/or generated by such operations.

FIG. 11 is a flow diagram of an exemplary method for accepting ad information from an advertiser and storing such information in a manner consistent with the present invention.

### § 4. DETAILED DESCRIPTION

The present invention may involve novel methods, apparatus, message formats, and/or data structures for facilitating the manual selection of one or more ads for insertion into a document, as well as transmission, posting, publication, or other distribution of the document including the ads. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventors regard their invention to include any patentable subject matter described.

In the following, definitions of terms that may be used in the specification are provided in § 4.1. Then, an overview of a context in which the present invention may operate are described in § 4.2. Exemplary embodiments consistent with the present invention are described in § 4.3. Thereafter, specific examples illustrating the utility of various exemplary embodiments consistent with the present invention are provided in § 4.4. Finally, some conclusions regarding the present invention are set forth in § 4.5.

§ 4.1 Definitions

Interactive online ads, such as those used in the exemplary systems introduced above, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, whether the ad was inserted into a document via a manual selection or via an automated arbitration process, an identifier of a user who manually selected the ad, the document with which the ad was served, the type of document with which the ad was served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (the number of times an ad is rendered) and the ratio of the number of conversions to the number of selections (or the number of some other earlier event) are both referred to as the “conversion rate.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as Meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader, etc.), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

§ 4.2 Overview

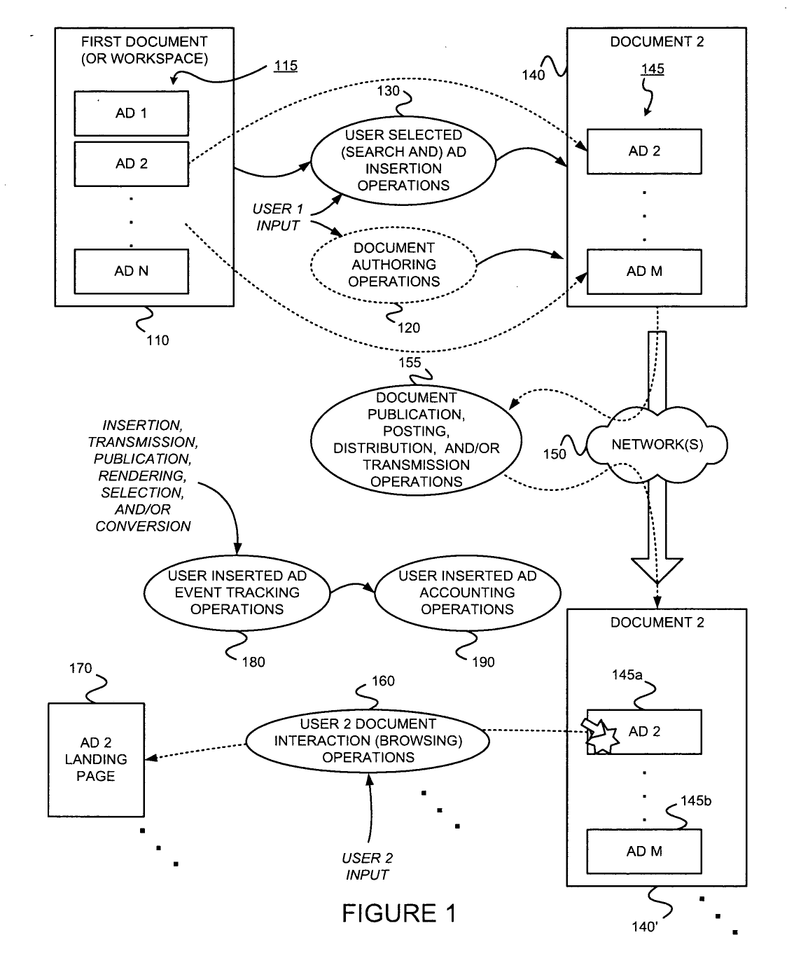

FIG. 1 is a bubble diagram of exemplary operations that may be performed in a manner consistent with the present invention, as well as information that may be used and/or generated by such operations. A first document (“document 1”) (or a workspace) 110 may include one or more ads 115. The ad(s) 115 of document 1 (or workspace) 110 might be rendered to a first user (“user 1”). Document authorizing operations 120 may be used by user 1 to create a second document (“document 2”) 140. User selected (search result and) ad insertion operations 130 may be used to allow user 1 to insert one or more ads 115 from document 1 (or the workspace) into document 2 140. Thus, document 2 may include one or more ads 145, at least one of which might be a copy (also referred to as an “instance”) of an ad 115 provided in the first document (or workspace) 110.

The first document (or workspace) 110 might be a search result page with ads relevant to a search query. Alternatively, the first document 110 might be a Web page with content-relevant ads. Naturally, other types of documents are possible. Alternatively, if the ads 115 are presented in a workspace 110, the workspace may be generated by the document authoring operations 120, or operations (not shown) working in concert with the document authoring operations 120 (e.g., a plug in, an extension, enabled script, etc.). The workspace 110 might be one of those described in the '466 application. If the ads are provided in a workspace 110, the workspace 110 might be associated with document 2 140. Finally, although only one first document (or workspace) 110 is shown, ads from more than one document (or workspace) might be inserted into the second document 140.

The second document 140 might be an email message, a blog posting, a message board reply, a text document, a multimedia document (e.g., image, audio, video, animation, graphical, etc.), an article, etc. The second document 140 is to be made available to one or more other users (e.g., transmitted, posted, published, distributed, etc.) as described below.

Document publication, posting, distribution, and/or transmission operations 155 might be used to publish, post, distribute, and or transmit one or more instances 140′ of the second document 140. For example, if the document authoring operations 120 are performed by computer-executable instructions for composing an email document, the operations 155 might be performed by computer-executable instructions for transmitting the email document to entities specified by the “To:”, “cc:”, and/or “bcc:” fields of an email. As another example, if the document authoring operations are performed by computer-executable instructions for composing an HTML document, the operations 155 might be performed by computer-executable instructions for posting or publishing the HTML document on a server on the Internet. Naturally, other types of document publication, posting, distribution, and/or transmission (which may be referred to in the specification simply as “distribution” without loss of generality) operations 155 are possible. The publication, posting, distribution, and/or transmission of the second document 140 may use one or more networks 150, such as the Internet for example.

Although the instance(s) 140′ of the second document 140 will often be an electronic document transmitted over, or stored on a network, such as the Internet, the instance(s) 140′ of the second document 140 may be physical. Thus, the instances 140′ of the second document 140 might be printed copies (e.g., of a bulletin, a pamphlet, a newsletter, a flyer, a handout, a magazine, etc.).

One or more instances 140′ of document 2 may be rendered to one or more other users (one of which will be referred to as “user 2”). User 2 might interact with the instance 140′ of document 2 using document interaction (e.g., browsing) operations 160. Such operations 160 might permit user 2 to perceive the ads 145 and/or select the ads 145. In this example, suppose user 2 can select the ads 145, and selects ad 2 145a. An ad landing Web page 170 (e.g., linked from the ad) may then be presented to user 2.

The user 2 document interaction operations 160 might be a Web browser, such as Firefox from Mozilla, Opera, Explorer from Microsoft, Navigator from Time Warner, etc. A Web browser may permit user 2 to perceive and interact with the ads of the instance 140′ of document 2 (e.g., a Web page, an email supported by a Web-based platform, a message board entry, a blog posting, etc.). Alternatively, or in addition, the user 2 document interaction operations 160 might be an email application (or some other application) residing on a client device of user 2. Naturally, the operations 160 might be some other application (e.g., either residing on a client device, Web-based, etc.) that enables user 2 to interact with (or at least perceive or view) the instance 140′ of the second document 140.

User inserted ad event tracking operations 180 might be used to track the occurrence of one or more of (a) user 1 insertion (e.g., via manual selection) of an ad into a second document, (b) transmission or distribution of the second document with the ad, (c) publication or posting of the second document with the ad, (d) rendering of an instance of the second document with the ad, (e) selection of the ad (e.g., by another user), (f) conversion on the ad (e.g., by another user), etc.

User inserted ad accounting operations 190 might be used to assess charges (e.g., to an advertiser), and/or provide rewards (e.g., to user 1) upon the occurrence of one or more of the events tracked by ad event tracking operations 180. Thus, in some implementations, users that insert an advertisement (or more specifically, manually select an ad for insertion) in content that they transmit, post, distribute, and/or publish may be given some form of reward or credit, perhaps if one or more conditions are met (e.g., if another user is presented with the document including the inserted ad selects the ad). The credit can be monetary or take some other form. Since it is believed that an advertisement inserted by a user into their document will very likely be relevant (and/or likely to be viewed by another user), a number of different business models are possible. For example, advertisers may be charged a premium or charged based on a different rate scale for user distributed ads (referred to as “UDA ads”).

§ 4.3 Exemplary Embodiments

§ 4.3.1 Exemplary Methods

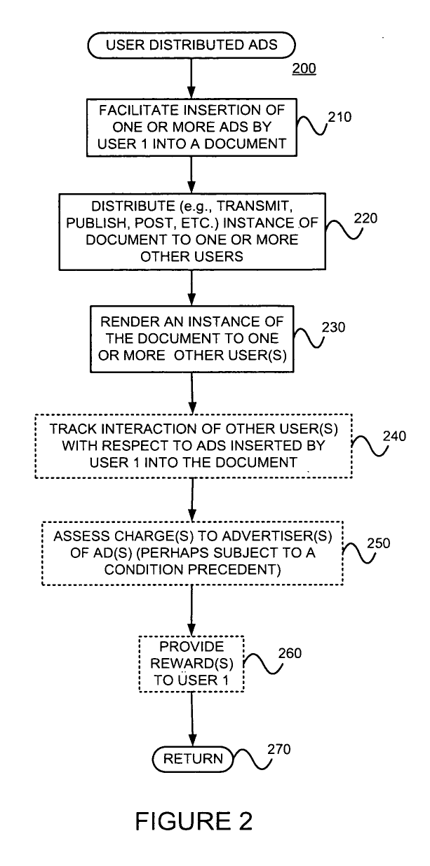

FIG. 2 is a flow diagram of an exemplary method 200 for facilitating the manual insertion and distribution of one or more ads in a document, as well as providing various incentives related to such ad(s), in a manner consistent with the present invention. Insertion of one or more ads (e.g., presented to a user in a first document or workspace) into a document by a user is facilitated. (Block 210) An instance of the document is then distributed (e.g., transmitted, published, or posted) to one or more other users. (Block 220) An instance of the distributed document is rendered to at least one other user. (Block 230). Depending on the business model used, the interaction(s) of the at least one other user with respect to the ads inserted into the document might be tracked. (Block 240) A charge is (or charges are) assessed to the advertiser(s) of the ad(s), perhaps subject to a condition precedent. (Block 250) Depending on the business model used, the first user (who inserted the ads into the transmitted, posted, or published document) might be provided with a reward, perhaps subject to a condition precedent. (Block 260) The method 200 is then left. (Node 270)

Referring back to block 210, exemplary techniques for facilitating the insertion, by a first user, of one or more ads into a document, are described in § 4.3.3.1 below.

Referring back to block 230, one or more instances of the document (including the inserted ads) may be distributed in various ways. For example, if the document is an email document, it may be transmitted over one or more networks (e.g., the Internet) to one or more recipients using a client-based application (e.g., Outlook from Microsoft) or a Web-based application (e.g., GMail from Google, Hotmail from Microsoft, etc.). As another example, if the document is an HTML document, it may be published on the Web by uploading it to a server (e.g., using a client-based authoring tool such as FrontPage from Microsoft, using a Web-based authoring tool such as Blogger, Writely, Google Page Creator, Hotmail's email composer, Orkut message composer, My Space message composer, etc., etc.). If the document is a video document, it may be published by uploading it to a server (e.g., Google Video). If the document is an instant message document, it may be published by Google TALK, etc. If the document is a message board post or blog post, it may be posted using Web-based message board and blogging applications. If the document is an audio document, it may be published by uploading it to a server (e.g., using pod-casting applications). Naturally, different types of documents may be distributed (e.g. transmitted, published, or posted) in different ways which will be apparent to those skilled in the art.

Referring back to block 230, the distributed document may be rendered to at least one other user in a number of ways. For example, if the document is an email document, it may be rendered via a client-based email application (e.g., Outlook, etc.) or a Web-based email application (e.g., GMail, Hotmail, etc.). If the document is an audio or video document, it may be downloaded to a player (e.g., an IPod from Apple, an MP3 player, a client-based player such as QuickTime from Apple, RealOnePlayer from Real Networks, Windows Media Player from Microsoft, etc.), or streamed to a player enabled on a browser. If the document is an HTML document published on the Web, it may be rendered using a browser (e.g., Firefox, Explorer, Netscape, Opera, etc.). Naturally, different types of documents may be rendered in various different ways which will be apparent to those skilled in the art.

Referring back to block 240, exemplary techniques for tracking user-ad interactions are described in § 4.3.3.2 below. Other actions, such as insertions of one or more ads into a document, transmissions, distributions, postings, publications of the document, renderings of the document, etc., may also be tracked.

Referring back to block 250, exemplary techniques for assessing charges to advertisers are described in § 4.3.3.3 below.

Finally, referring back to block 260, exemplary techniques for providing rewards or incentives to the first user are described in § 4.3.3.4 below.

§ 4.3.2 Exemplary Apparatus

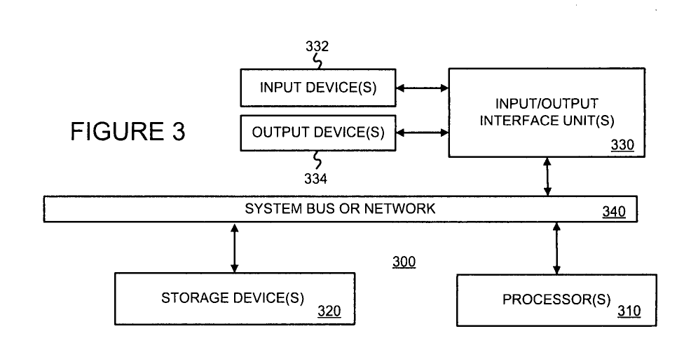

FIG. 3 is a block diagram of apparatus 300 that may be used to perform at least some operations, and store at least some information, in a manner consistent with the present invention. The apparatus 300 basically includes one or more processors 310, one or more input/output interface units 330, one or more storage devices 320, and one or more system buses and/or networks 340 for facilitating the communication of information among the coupled elements. One or more input devices 332 and one or more output devices 334 may be coupled with the one or more input/output interfaces 330.

The one or more processors 310 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 320 and/or may be received from an external source via one or more input interface units 330.

In one embodiment, the machine 300 may be one or more conventional personal computers. In this case, the processing units 310 may be one or more microprocessors. The bus 340 may include a system bus. The storage devices 320 may include system memory, such as read only memory (ROM) and/or random access memory (RAM). The storage devices 320 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 332, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 310 through an appropriate interface 330 coupled to the system bus 340. The output devices 334 may include a monitor or other type of display device, which may also be connected to the system bus 340 via an appropriate interface. In addition to (or instead of) the monitor, the personal computer may include other (peripheral) output devices (not shown), such as speakers and printers for example.

The storage devices 320 might include one or more a computer-readable media having stored thereon an advertisement-related data structure. The advertisement-related data structure might include one or more of (a) creative information, (b) first compensation information used for determining whether and how to serve the advertisement under an automated arbitration process, and (c) second compensation information used for determining an amount to assess an advertiser for the occurrence of one or more events (e.g., one or more of (A) a manual selection of the advertisement for insertion into a document, (B) a manual selection of the advertisement for insertion into a document and a transmission of the document to a user, (C) a manual selection of the advertisement for insertion into a document and a publication of the document, (D) a manual selection of the advertisement for insertion into a document and a posting of the document, (E) a manual selection of the advertisement for insertion into a document, a transmission of the document to a user, and a rendering of the document, (F) a manual selection of the advertisement for insertion into a document, a publication of the document, and a rendering of the document, (G) a manual selection of the advertisement for insertion into a document, a posting of the document, and a rendering of the document, (H) a manual selection of the advertisement for insertion into a document, a transmission of the document to a user, a rendering of the document and a user selection of the advertisement, (I) a manual selection of the advertisement for insertion into a document, a publication of the document, a rendering of the document and a user selection of the advertisement, and (J) a manual selection of the advertisement for insertion into a document, a posting of the document, a rendering of the document, and a user selection of the advertisement), and (d) secondary document reference information (e.g., a link to a landing page). This information might have been entered via an advertiser user interface consistent with the present invention.

The operations described above may be performed on one or more computers. Such computers may communicate with each other via one or more networks, such as the Internet for example.

§ 4.3.3 Refinements, Extensions and Alternatives

§ 4.3.3.1 User 1 Insertion of Ads

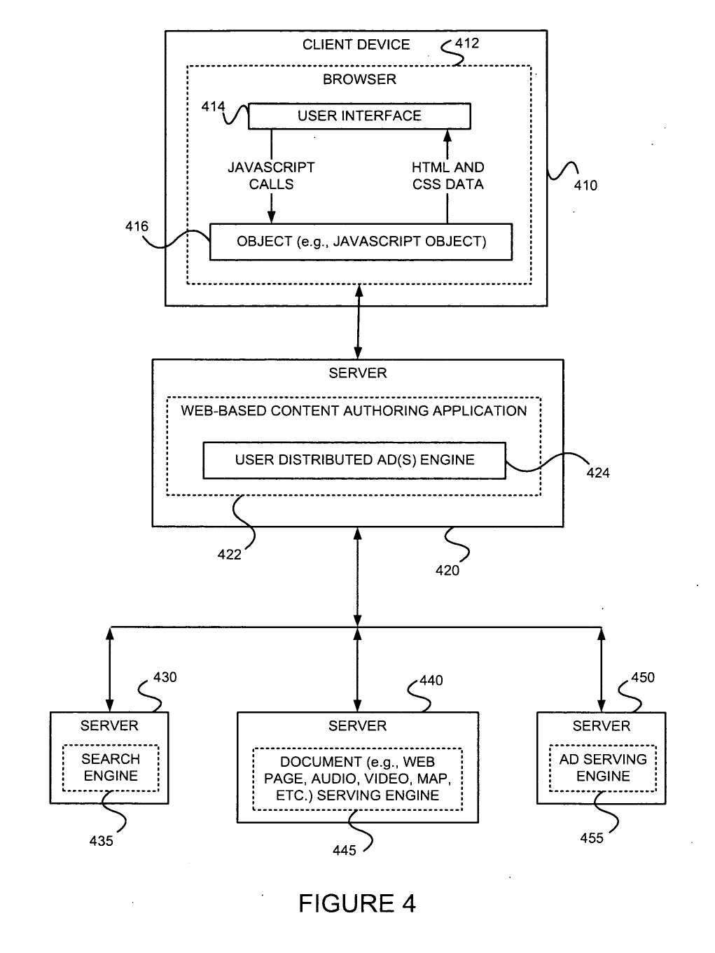

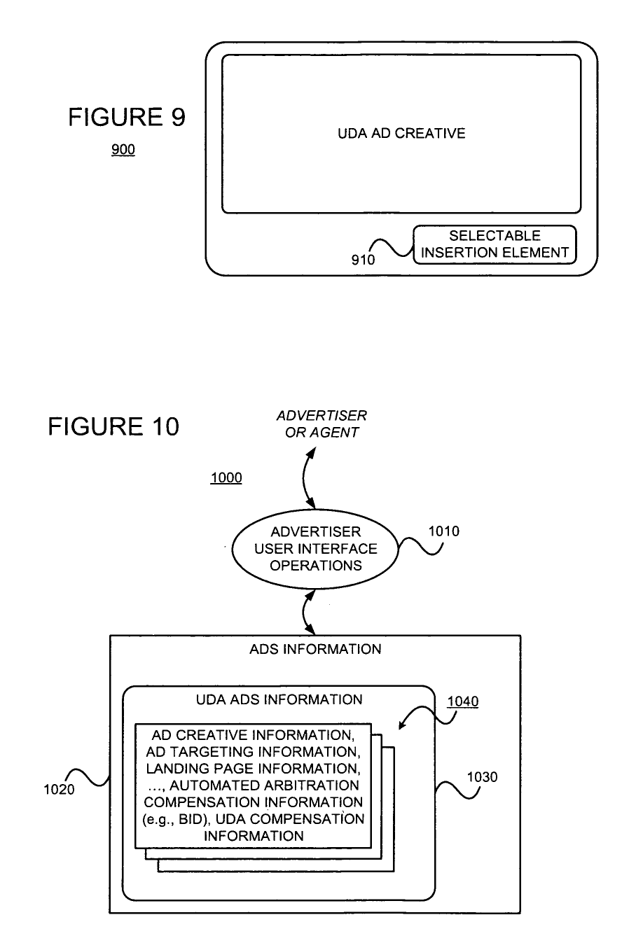

Embodiments consistent with the present invention may use techniques described the '466 application, to facilitate the user insertion of ads from a first document or workspace, into a second document. FIG. 4 (which is similar to FIG. 10 of the '466 application) is a diagram illustrating exemplary components in a UDA system. As shown, a client device 410 communicates with UDA engine 424 of a Web-based authoring application 422 at a server 420. The server 420 may in turn communicate with server 450 (supporting an ad serving engine 455). The server 420 might also communicate with one or more of server 430 (supporting a search engine 435), server 440 (supporting a document (e.g., Web page, audio, video, map, etc.) serving engine 445) and other types of servers (not shown).

In this exemplary implementation, at least some portions of the content authoring application 422 (e.g., an email application, etc.) might be Web-based, providing functionality via a browser 412 of the client device 410 on an on-demand basis. At browser 410, the content authoring application (portion(s)) might include, for example, an object 416 such as a JavaScript object for example, that interfaces with a user interface portion 414 to provide the final user interface that is displayed in the browser 412 based on, for example, HTML (hyper-text markup language) and CSS (cascading style sheets) data supplied from JavaScript object 416. Thus, the JavaScript object 416 can accept and process the user input. As one example, timer-based code that detects input idle, gets the information out of an HTML input element and starts firing search requests could be provided.

User interface portion 414 and JavaScript object 416 might together act to reduce the start-stop, start-stop, nature of traditional browser Web-based applications, as the JavaScript object 416 adds a client-side layer that can handle many of the user interactions with user interface portion 414. Instead of loading a Web page at the start of a user session, the browser 412 may load JavaScript object(s) 416 from the server 420 (or, alternatively, from a local cache). JavaScript object(s) 416 may be responsible for both rendering the interface the user sees, and communicating with content authoring application component 422 of the server 420 on the user's behalf.

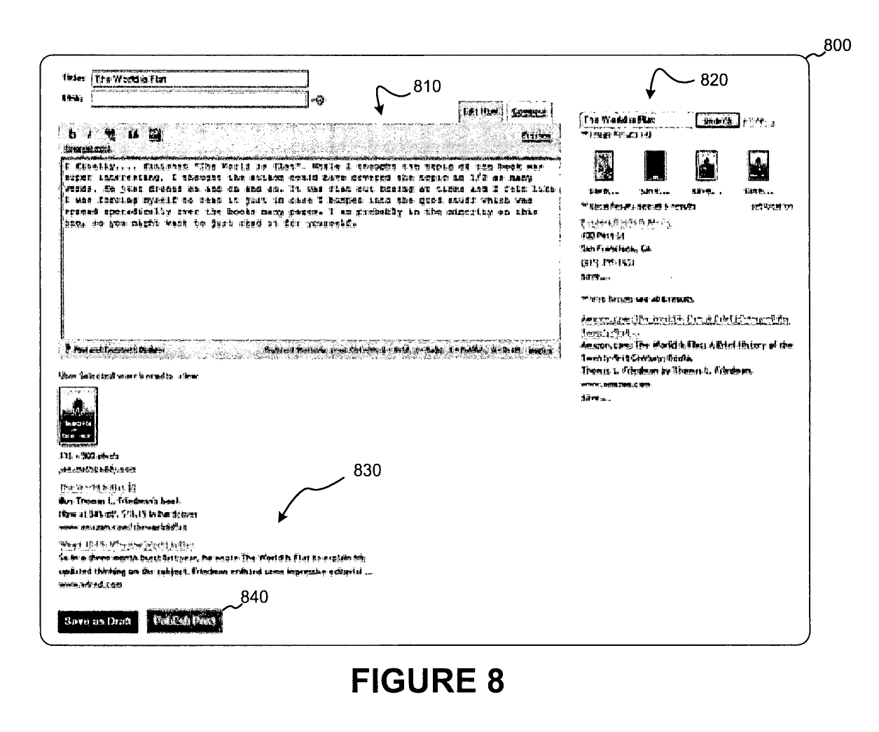

JavaScript object(s) 416 may be a dynamically configured object that supports dynamic selection of which network services, such as which ad serving engine 455 services, to use. JavaScript object(s) 416 may implement a number of different functions at the client device 410. For example, JavaScript object(s) 416 may allow the interface to be positioned where desired in the client display. Additionally, JavaScript object(s) 416 may implement an ad control object that limits the number of ads served on a document or workspace to a small number of highly relevant ad results (pertaining to search query information, content of a (e.g., specified) document, etc.). The ad control object may annotate each ad with an element that, when clicked or otherwise selected, allows the user to save (e.g., cut and/or copy) the ad for use by the Web-based content authoring application 422. FIG. 9 illustrates an exemplary UDA ad 900, consistent with the present invention, which includes a selectable insertion element 910.

In some implementations consistent with the present invention, JavaScript object(s) 416 may be an object that is designed to be easily integrated into existing Web-based JavaScript applications, thus providing a convenient application programming interface (“API”) through which programmers can incorporate UDA into their programs.

UDA engine 424 may provide an interface with JavaScript object(s) 416. In response to JavaScript object(s) 416, a UDA interface may annotate ad requests, request ads through appropriate ad server(s) 450 (and perhaps search results through search engine(s) 435, and/or documents through document serving engine(s) 445), and serialize the returned ads. Thus, the servers 430, 440 and 450 may return search results, Web pages, audio documents, video documents, maps, etc. (or links thereto), and ads in response to requests from UDA engine 424.

In some embodiments consistent with the present invention, the UDA engine may include executable components which may be provided as client-side components. In some embodiments consistent with the present invention, the UDA engine may include executable components which may be provided as (e.g., Web-based) server-side components. Finally, in some embodiments consistent with the present invention, the UDA engine may include both client-side and (e.g., Web-based) server-side components. The UDA engine may permit ads to be provided in a document or workspace. For example, a user could submit a search query and be provided with relevant ads. As another example, a user could copy and paste or cut and paste the ads from a search results Web-page (e.g., AdWords ads provided on a Google search results Web page). As yet another example, a user could request ads relevant to the content of a given Web page or other document. As still another example, a user could copy and paste or cut and paste ads from a Web page (e.g., AdSense ads provided on a Web page participating in the Google AdSense program) or some other document. In any of the foregoing embodiments, the ads themselves may include a user-selectable object which, when selected, causes the ad to be inserted into a work space and/or into a document being created or authored.

§ 4.3.3.2 User-Ad Interaction Tracking: Performance Tracking

Various user-ad interactions may be tracked, particularly those upon which advertiser charges and/or user rewards are conditioned. UDA ad insertions (e.g., cutting and pasting, copying, selecting an insertion object, etc.), UDA ad distributions (e.g., publication, posting, distribution, and/or transmission of document including one or more UDA ads), UDA ad impressions, UDA ad selections, UDA ad conversions, may be tracked, and UDA ad performance metrics such as UDA ad insertion rate, UDA ad distribution rate, UDA ad selection rate (e.g., click through rate or CTR), UDA ad conversion rate, etc., may be tracked and/or generated. Some embodiments consistent with the present invention may track such events and/or generate such performance metrics on a more specific basis. For example, any of the foregoing may be tracked and/or generated per (a) recommending user 1, (b) document (type), (c) {recommending user 1, document (type)} pair, etc.

Thus, for example, the CTR of a UDA ad might be higher if the recommending user is more trusted or influential. As another example, an ad inserted into an email might have a higher CTR than for an ad inserted into a message board reply. It might be useful to track this so that CTR's can be normalized to remove the influence of which user recommended it, what type of document it was rendered on, etc. Other UDA ad performance measurements may be similarly processed.

Additional information such as transmission, publication, posting, etc., (e.g., raw counts and/or per impression rates) may be tracked. For example, a user may send a lot of emails that are never opened, or publish a lot of documents that are never viewed, or viewed infrequently. In addition, as was the case above, any of the foregoing may be tracked per (a) recommending user 1, (b) document (type), (c) {recommending user 1, document(type)} pair, etc.

Note further that user recommendations (e.g., inserting an ad into a document that is distributed) might affect an advertiser reputation score. Such an advertiser reputation score might be a factor considered in various ad arbitrations. Alternatively, or in addition, such an advertised reputation score might be conveyed (e.g. via a visual indication) to user 1.

As another example, in some current advertising systems, arbitration among ads competing for an ad spot considers an actual or predicted selection rate (e.g., click-through rate) of the ad. Similarly, arbitrations may factor in one or more of the various UDA ad performance, such as the tracked performance metrics described above.

§ 4.3.3.3 Assessing Advertiser Charges

This section describes both (1) events upon which advertisers might be assessed a charge, and (2) the amount of such charges.

§ 4.3.3.3.1 Events Upon which Advertisers might be Assessed a Charge

There are various events for which the advertiser can be charged. Such events might include one or more of (a) upon user 1 impression, (b) upon user 1 selection (click), (c) upon user 1 insertion into document, (d) upon (c) and document transmission or distribution (e.g., for email document, or document attached to email), (e) upon (c) and posting of the document (for message board posting, blog entry, review posting, etc.), (f) upon (c) and publication of the document (e.g., an HTML page published to the Web by saving on an accessible server, (g) upon subsequent user (user 2) impression (perhaps capped at a maximum amount), (h) upon user 2 selection (click) (perhaps capped at a maximum amount), (i) upon user 2 conversion (perhaps capped at a maximum amount), etc.

In some embodiments consistent with the present invention, the advertiser might be assessed a charge for more than one event, or a first type(s) of event(s) for by user 1 and a second type(s) of event(s) for other users.

§ 4.3.3.3.2 Amount of Assessed Charge(s)

The amount of charge assessed to an advertiser will likely be different from normal position auctioning systems (e.g., an auction scoring ads by CTR * CPC) where competing advertisers submit bids for various keywords or other serving constraints, and which typically consider an ad's offer (e.g., bid) and performance (e.g., CTR). With UDAs, user 1 selects and places the ad. Although there might be an initial automated arbitration which might dictate whether and how the ads are presented to user 1, and which therefore might indirectly affect which ads user 1 inserts into a document to be distributed, the user might end up inserting ads and distributing UDA ad-carrying documents in unexpected and uncontrollable ways.

In some embodiments consistent with the present invention, the advertiser might be assessed a flat charge per event, where, as discussed above, the event may be one or more of (a) upon user 1 impression, (b) upon user 1 selection (click), (c) upon user 1 insertion into document, (d) upon (c) and document transmission or distribution (e.g., for email document, or document attached to email), (e) upon (c) and posting of the document (for message board posting, blog entry, review posting, etc.), (f) upon (c) and publication of the document (e.g., an HTML page published to the Web by saving on an accessible server, (g) upon subsequent user (user 2) impression (perhaps capped at a maximum amount), (h) upon user 2 selection (click) (perhaps capped at a maximum amount), (i) upon user 2 conversion (perhaps capped at a maximum amount), etc. In at least some embodiments consistent with the present invention, the advertiser might be assessed a bid charge for one or more of the foregoing events. (However, this might not be preferred since the bid amount should not affect (at least directly) whether or not user 1 copies the ads into their document so advertisers have no (or at least less) incentive to bid high.). In some embodiments consistent with the present invention, the advertiser might be assessed a charge for one or more of the foregoing events that is a function of (e.g., the same as) the bid or offer used in other advertising system arbitrations (e.g., Google's AdWords or AdSense auctions).

In some embodiments consistent with the present invention, the amount the advertiser is assessed might be a function of number of other ads on the user 1 document, and/or number of other UDA ads on the user 1 document. This might depend on the event for which the advertiser is charged. For example, for per-impression charges, a UDA ad presented by itself is likely to be much more valuable (e.g., much more likely to be clicked on) than if presented with a number of other ads. (This might not be an issue for per-selection charges, or per-conversion charges.)

In some embodiments consistent with the present invention, the amount the advertiser is assessed might be a function of other ads (e.g., AdSense ads in a GMAIL message) displaced by the UDA ad, or in some way diluted by the UDA ad.

If the ad is initially served/placed on the first document or workspace subject to an arbitration (which might consider bid and/or ad performance), and subsequently inserted into the second document subject to a manual selection, charges assessed to the advertiser for both might be different for these two different placements (e.g., a bid per click for first placement (presented to user 1 on document 1 or workspace), and flat amount per impression for second placement (presented to subsequent user(s)).

In some embodiments consistent with the present invention, the amount assessed to an advertiser might be capped. In some embodiments consistent with the present invention, the amount assessed to the advertiser for any UDA ad events might be a fully paid-up license. In some embodiments consistent with the present invention, the amount assessed to the advertiser for any UDA ad events might be a periodic subscription charge. Thus, the advertiser might be assessed a subscription or license charge covering a number of UDA ad events, perhaps without regard to how few or many of those events occur.

§ 4.3.3.3.3 Advertiser User Interface

Recall from FIG. 3 that storage devices 320 might include one or more computer-readable media having stored thereon an advertisement-related data structure. Recall further that the advertisement-related data structure might include one or more of (a) creative information, (b) first compensation information used for determining whether and how to serve the advertisement under an automated arbitration process, and (c) second compensation information used for determining an amount to assess an advertiser for the occurrence of one or more events. FIG. 10 is a bubble diagram of exemplary operations 1010 that may be performed in a manner consistent with the present invention, as well as information 1020 that may be used and/or generated by such operations. As shown in FIG. 10, an advertiser (or an agent of an advertiser) might interact with advertiser user interface operations 1010 (which may include front end operations and back end operations) to obtain UDA ad information. This information is stored as ads information 1020.

The ads information 1020 might include UDA ad information 1030. The UDA ad information 1030 might include information 1040 for a number of UDA ads. Each of the UDA ads might have associated information including ad creative information, automated arbitration compensation information, UDA event compensation, etc.

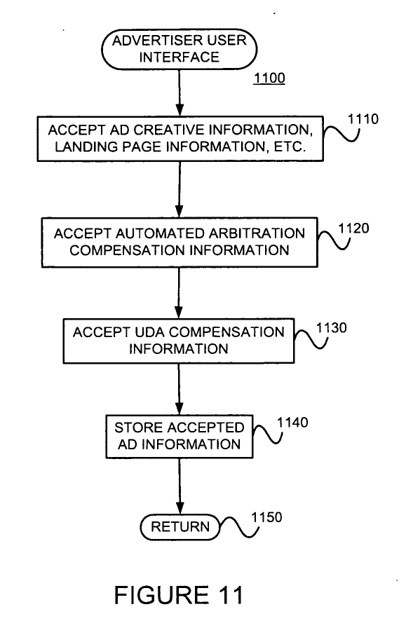

FIG. 11 is a flow diagram of an exemplary method 1100 for accepting ad information from an advertiser and storing such information in a manner consistent with the present invention. Ad creative information (and perhaps other information such as landing page information, targeting information, etc.) is accepted. (Block 1110) Automated arbitration compensation information (e.g., offer per impression, offer per selection, offer per conversion, maximum offer per impression, maximum offer per selection, maximum offer per conversion, etc.) is accepted (Block 1120) UDA event compensation information (e.g., as discussed above) is accepted (Block 1130). The accepted ad information is stored (Block 1140) before the method 1100 is left (Node 1150).

In some embodiments consistent with the present invention, ad information might include information indicating whether or not the ad is eligible to have UDA functionality.

§ 4.3.3.4 Providing User 1 Rewards

Some embodiments consistent with the present invention might reward user 1 for inserting a UDA ad, and/or transmitting, publishing, posting a document including an inserted UDA ad. Such a reward might be conditioned on (a) user 1 insertion of the UDA ad into the second document, (b) transmission or distribution of the second document with inserted UDA ad, (c) publication or posting of second document with inserted UDA ad, (d) subsequent user (user 2) impression (perhaps capped), (e) subsequent user (user 2) selection (e.g., click) (perhaps capped), and/or (f) subsequent user (user 2) conversion (perhaps capped).

Some embodiments consistent with the present invention might condition the reward, or a portion thereof, to an event that also triggers an assessment of an advertiser charge (as described above).

In some embodiments consistent with the present invention, the reward might include one or more of (a) a monetary amount, (b) an enhanced reputation or reputation increase of user 1, and (c) a credit.

§ 4.3.3.5 Ancillary Factors that Might Affect Ads (and/or Search Results or Other Results) Presented to User 1.

Suppose that the first document or workspace includes ads (and perhaps search query results or other results) determined using a search query entered by user 1. Typically the ads might be found to be eligible using targeting criteria (e.g., targeting keywords, location, etc.) and search results, if any, might be scored using IR relevance and PageRank for example. However, in the case where user 1 is authoring a document, there might be other useful factors such as the content authored (e.g., content of an email message), or attributes of the author (e.g., email sender), attributes of user 2 (e.g., email recipient(s)) (See, e.g., U.S. patent application Ser. No. 10/452,830 (referred to as “the '830 application” and incorporated herein by reference), titled, “SERVING ADVERTISEMENTS USING INFORMATION ASSOCIATED WITH E-MAIL”, filed on Jun. 2, 2003 and listing Jeffrey A. DEAN, Georges R. HARIK, and Paul BUCHHEIT as inventors), a (typical) blog reader, a (typical) message board visitor, etc.), etc., that might be helpful in determining the most useful ads and perhaps other results. Such factors might influence the determination of the most useful ads and perhaps other results.

Present ad arbitration systems (e.g., auctions) typically consider information (e.g., bids, budgets, etc.) that is relatively “fresh.” However, in the context of email, message board or blog postings, Web page publications, etc., impressions/selections/conversions on an inserted UDA ad might occur well into the future. At such time, the advertiser associated with the inserted UDA ad might have left the advertising network (e.g., AdWords, AdSense, etc.), might have exhausted their budget, etc. In such instances, the advertising network might not be able to charge the advertiser. (Earlier solutions to this type of problem included running an ad placement auction when an email newsletter is opened, not when sent. However, this solution is not an option for manually selected ads inserted into a document prior to transmission, publication, or posting.) Therefore, some embodiments consistent with the present invention might consider predicted information (e.g., probability that the advertiser will exhaust budget before occurrence of event upon which advertiser is charged) when determining which ads to present to user 1 in the first place.

Given the fact that UDA ads are selected manually (bid amount having no affect (or at least no direct affect) on whether or not the user selects the ad for insertion), there is the potential for an advertiser who has a small budget or who has left an advertising network to continue to reap the benefit of having its ad get impressions, selections, conversions, etc., for as long as the document on which is resides can be rendered. One possible solution would be to give UDA ads a finite time-to-live, either in terms of time, number of impressions, number of selections, an estimated value of any of the foregoing, etc. A related solution would be to let UDA ads live so long as the advertiser has enough budgeted, or continues to pay some sort of subscription fee. Either of these exemplary embodiments may be implemented as follows. If an UDA ad selection is redirected (e.g., to an ad landing page) through the advertising system's servers, if the link is from a UDS ad, a click when the advertiser is out of budget or otherwise considered not entitled to receive ad impressions, selections, conversions, etc., could cause a generic landing page to be loaded instead of the ad's landing page. The advertiser might be informed about a missed opportunity. If the advertiser adds more to their budget or otherwise becomes eligible again, then the links can start working again.

Another solution might be to provide UDA-enabled ads with enhanced features (e.g., a more prominent “insert” element, etc.) as long as the advertiser continues of have enough budget, continues to pay a subscription fee, or has a fully paid perpetual subscription.

§ 4.3.3.6 Mix of Types of Content to Present to User 1 in the First Document or Workspace

In addition to ads presented in document 1 or workspace, there might be additional sources of different types of insertable content to present to user 1 such as, for example, search results, local search results, maps, images, etc. These might be presented in predetermined numbers, in a predetermined order (e.g., a smaller set including four search results and two ads, or a larger set including eight search results and four ads). However, some embodiments consistent with the present invention might analyze the content of the document being authored by user 1 when determining what mix of “result” types to present to user 1. For example, if the document being authored by user 1 includes terms like “purchase”, “buy”, “price”, “delivery”, “shipping”, “payment”, etc., the mix of “results” might include more ads. As another example, if the document being authored by user 1 includes terms like “learn”, “find out”, etc., the mix of “results” might include more search results. As yet another example, if the document being authored by user 1 includes terms like “where”, “find”, etc., the mix of “results” might include more maps. As still another example, if the document being authored by user 1 includes terms like “look(s) like”, “pretty”, “ugly”, “view”, “see”, etc., the mix of “results” might include more images.

Similarly, some embodiments consistent with the present invention might analyze the recommending user and/or the document type (e.g., email, Webpage, blog posting, message board reply, etc.) into which the ad might be copied when determining what mix of “result” types to present to user 1. For example, if UDA ads perform much better in emails than in blogs, and if the user is working on an email message, the mix of “results” might include more ads than if the user is working on a blog. As another example, if UDA ads inserted by user 1 A perform much better than UDAs inserted by user 1 B, the mix of “results” returned to user 1A might have more ads than the mix of “results” returned to user 1B for an otherwise identical situation.

§ 4.3.3.7 Policies for Mixing User Distrubuted Ads with Other Ads on a Given Document

Some content creation applications might already insert ads competing in an arbitration (e.g., the GMAIL Web-based email service from Google already provides AdSense ads in the email related to the content of the email). Some embodiments consistent with the present invention might implement policies where there is a potential mix of automatically determined and inserted ads (e.g., AdSense ads) and UDA ads.

Consider, for example, implementing UDA ads in the GMAIL Web-based email service. Under an exemplary policy consistent with the present invention, AdSense ads might be provided in a margin (as they are now) of the email while UDA ads might be provided in the body of the email (or wherever the user 1 places them). Under an alternative policy consistent with the present invention, both types of ads might be provided in a margin. Under an exemplary policy consistent with the present invention, UDA ads might be provided above (or in a more preferred location) than AdSense ads.

Continuing the foregoing example, there might be a policy specifying a maximum number of ads. Under an exemplary policy consistent with the present invention, UDA ads might trump (displace or take a place that would otherwise be occupied by) one or more AdSense ads.

Continuing the foregoing example, if there are different types of ads from different sources, in some exemplary embodiments consistent with the present invention, the ads might include a source indicator—“Google AdSense Ads” “User Recommended/Selected Ads” “User Recommended Google Ads”, etc.

§ 4.3.3.8 Tracking Associations Among User Distributed Ads

Some embodiments consistent with the present invention might track associations among user distributed ads (e.g., on one or more of a per inserting-user basis, a per document basis, a per document type basis, per email sender (attribute)-recipient (attribute) basis, over all inserting users, over all documents, etc.). For example, a user might insert UDA ads pertaining to seemingly different topics into a given document that is then distributed. It might be useful to track associations among the different ad topics. Whether or not such associations become statistically significant can be determined.

As a first example, consider a user that is helping a friend who is visiting San Francisco, Calif. The user might send their friend an email with UDA ads concerning hotels and restaurants in San Francisco. In addition, the user might have included UDA ads concerning the Monterrey Aquarium and Napa Valley wineries, in the email. The concepts of the ads provided in the email document might be San Francisco, hotels, restaurants, Monterrey, attractions, aquariums, Napa Valley, wineries, wine, etc. If two or more of these concepts co-occur enough, the ad serving system might infer that such concepts are related.

As a second example, consider a car dealer that sends an email message to a customer that has scheduled an oil change. Assume that the email message indicates that the oil change is only going to take 45 minutes and includes UDS ads pertaining to things the customer can do while they wait—e.g., an ad (or some other result) for a chair massage at the spa across the street (a local search ad result), an ad (or some other result) for the Internet cafe next door, and an ad (or some other result) to take a test drive in the new Toyota Tacoma. All of these options might be “results” provided by various servers. (Recall, e.g., FIG. 4.) The fact that the car dealer bundled them together into a message might be used to infer that they are related. If this happens enough, a pattern that isn't initially obvious can be discerned. As this second example illustrates, concepts from different types of“results” (e.g., ads, search results, local ads, local results, maps, etc.) inserted by the car dealer can be associated.

§ 4.3.3.9 Using Information from Manually Inserted UDA Ads and/or Manually Inserted “Results” to Help when Automatically Determining Ads, such as Content-Relevant Ads for Example

Some ad serving systems, such as AdSense from Google for example, analyze the content of a document (e.g., a Web page, an email, etc.) to determine, automatically, ads relevant to the content. Some embodiments consistent with the present invention might also consider the content of UDA ads and/or other user-inserted results when determining, automatically, other ads to serve with the document. Some embodiments consistent with the present invention might consider information linked from (or otherwise associated with) such UDA ads and/or other user-inserted results when determining, automatically, other ads to serve with the document. In this way, automatically determined content-relevant ads might be determined using content from manually-inserted UDA ads and/or other manually inserted results

Consider, for example, a user that sends an email to members of her book club informing the members of what next month's book is. Suppose that the user has manually inserted into the email “results” such as an image of the book cover, a UDS search result to a review of the book, and a normal amazon.com search result. When the recipients of this email open it, side-bar, content-relevant ads might also be provided. Such side-bar, content-relevant ads might have been automatically determined using, perhaps among other things (e.g., the textual content of the email message), information derived from the manually inserted “results.” For instance, Amazon might have an ad offering free shipping for purchases made in the next 48 hours.

In addition to using the content of the manually inserted “results” to determine content-relevant ads, such manually inserted “results” might be a condition upon which serving ads and/or add-on ads (e.g., coupons) is triggered. Consider, for example, two people using instant text messages concerning lunch options for a get-together on Friday. One of the messages might include a manually inserted UDS “local results” for the restaurants “pf Changs” and “Taco-Bell.” In a text message side-bar, both Taco-Bell and pf Changs might provide coupon-type ads that were triggered by the manually inserted local results included in the message.

As can be appreciated from the foregoing example, UDA ads and UDS results might be used to help determine content-relevant ads automatically, and/or might be a condition upon which the serving of ads (e.g., coupon ads) is conditioned.

§ 4.4 Examples Illustrating Operations in Exemplary Embodiments Consistent with the Present Invention

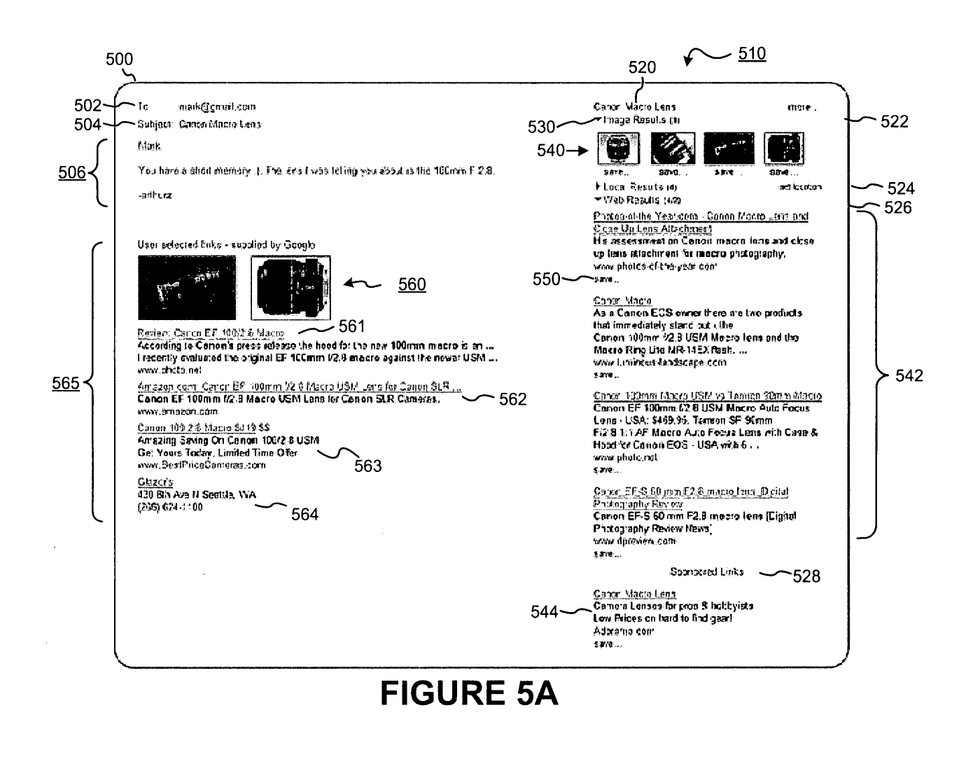

Some embodiments consistent with the present invention may provide a graphical interface that includes a UDA component. FIG. 5A is a diagram of an exemplary email interface 500. Email interface 500 may include fields such as “To:” field 502, “Subject:” field 504, and message field 506 in which the user may compose an email message in a typical manner. Additionally, in this exemplary implementation, interface 500 includes a UDA workspace 510. In some implementations, UDA workspace 510 may be presented as a graphical window, sidebar, toolbar, or other element of interface 500 that the user can selectably display or hide from view. As shown, UDA workspace 510 includes a search query field 520 and a number of sections 522-528. In this example, sections 522-528 include: image search result section 522, local search result section 524, general Web search result section 526, and search-relevant advertisement result section 528. A selectable graphical button, such as arrows 530 may allow the user to toggle between hiding and displaying each of the sections 522-528. As shown, results in local search result section 524 (“local results”) are hidden while sections 522, 526, and 528 are configured to show results. In some implementations, the user of the email application may be able to customize which of the sections are shown in a default UDA workspace 510.

The user may, at some point while composing the email, enter a search query into search query field 520. In some implementations, instead of the user manually entering a search, search queries may be automatically generated and/or executed, such as by generating search queries (or ad requests) based on content entered by the user, or semi-automatically generated and/or executed, such as by allowing searches to be performed when a user “hovers” over a word or selection with a cursor icon. In response, the search query may be provided to an ad server, and perhaps one or more other servers. (Recall, e.g., 430, 440 and 450 of FIG. 4.) In this example, the search query may be provided to an ad server as well as an image search engine, a local Web search engine, and a general Web search engine. The results are returned from each of these four “search objects” and may then be rendered for viewing by user 1 as illustrated in screen 500 of FIG. 5A. In some implementations, the user may select one of the search results to view the underlying document in a separate browser window.

As illustrated in the example of FIG. 5A, user 1 entered the search query “Canon Macro Lens” into search query field 520. The returned results include a number of images 540 related to this search, a number of relevant Web sites 542 related to the search, and an advertisement 544 related to this search (some of which are not shown in the workspace 510 if they were already selected by user 1 to be included in the email). Each of the returned results may include a selectable element (e.g., an “insertion” object) that allows the user to insert the search result into the message being composed. In this implementation, a user selectable “save” element 550 is shown below each of the results.

User 1 may decide to include one or more of the results in the email. In this example, user 1 may do so by simply selecting the appropriate “save” element 550, which causes the corresponding result to be copied (or moved) into the email, such as to the message field 506 of the email. As shown, in this example, user 1 has selected two images 560, two general Web results 561 and 562, an ad 563, and a local search result 564 (collectively referenced by number 565), for inclusion in the email being composed. In one implementation, the results may be automatically placed below message field 506 in the email. In other implementations, user 1 may be enabled to control the placement of the results in the email, such as by graphically dragging different results to different positions in the email. In some embodiments consistent with the present invention, user 1 may be enabled to implement other editorial controls, such as providing the ability to annotate results or to add an indication of the search query that was used to generate the result.

User 1 may continue to edit the content, enter or refine search queries, and select UDA ads for the content until he or she is ready to distribute (e.g., transmit, publish, or post) the content. In the example, of FIG. 5A, user 1 may enter a “send email” command when he or she is ready to send the email. FIG. 5B illustrates the instance of the email message 590 provided to the recipient. The recipient of the email message 590 may be able to conveniently view a Web page linked from the instance of the UDA ad 563′ (also referred to as the ad landing page) by selecting the ad.

As can be seen from FIG. 5B, the selected results 565′ are formatted in a visually appealing manner and should therefore be more useful than typical links that a user would normally paste into content. For example, the inserted images 560′, search results 561′, 562′, ad 563′ and local search result 564 may each include an actual link. Additionally, as discussed above with reference to FIG. 5A, user 1 was able to select results via a simple process, such as by a single mouse click element 550 or by a “drag and drop” selection operation associated with element 550, thereby enabling even relatively unsophisticated computer users to enhance their content by adding results. The element 550 may be textual as shown, graphical, etc.

In some embodiments consistent with the present invention, the ads made available for insertion by user 1 might consist of, or include, local ads.

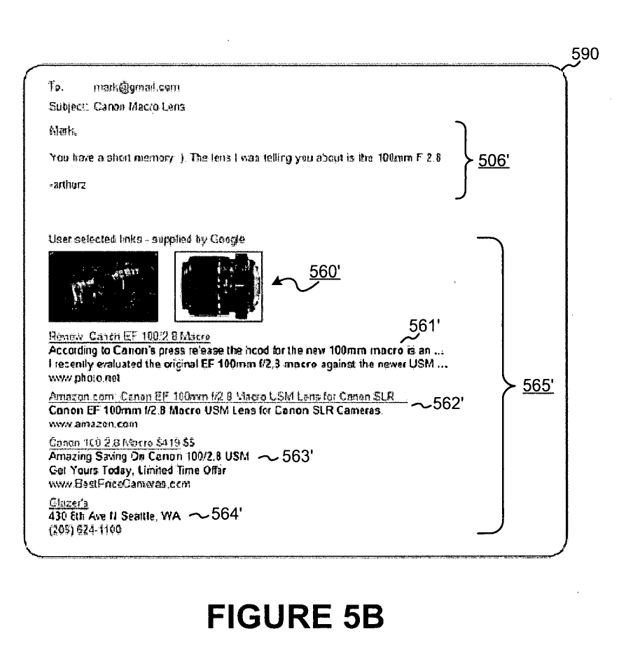

The foregoing description of UDA was primarily in the context a first user manually inserting an ad into an email document, and sending the resulting email document to one or more other users. As previously described, UDA can be applied to other forms of documents created using other authoring techniques and which are viewed by other users via different channels. FIGS. 6-8 illustrate some additional exemplary applications of UDA.

FIG. 6 is an exemplary interface 600 for applying UDA to a message board environment in a manner consistent with the present invention. A Web message board can generally be defined as a facility on the Web for holding discussions (e.g., typed text, or spoken). Message boards are typically organized into topics in which users post messages relating to the appropriate topic. In FIG. 6, an exemplary message board interface 600 is presented (e.g., via a Web browser) to a user. As shown in interface 600, a first user (R J Peterson) has posted a message 610 asking for advice relating to a bicycle crank. A second user (mark1) replies with a message 615. In this example, it is assumed that the second user mark1 used UDA to insert a number of results 620 into the reply message 615. In this example, the results 620 include images 625 of the cranks under discussion, an advertisement 630 for a bicycle store mentioned in message 615, a link 635 to a Website of the company that produces the cranks, and a link 640 pointing to a local distributor of the cranks. As this example illustrates, using UDA, the second user—mark1—responding to message 610 was able to manually select results (e.g., having links) that he considered to be relevant to the topic under discussion, for insertion into his reply message 615. As compared with transmitting an email document, the author (second user: mark1) posted his message board reply document.

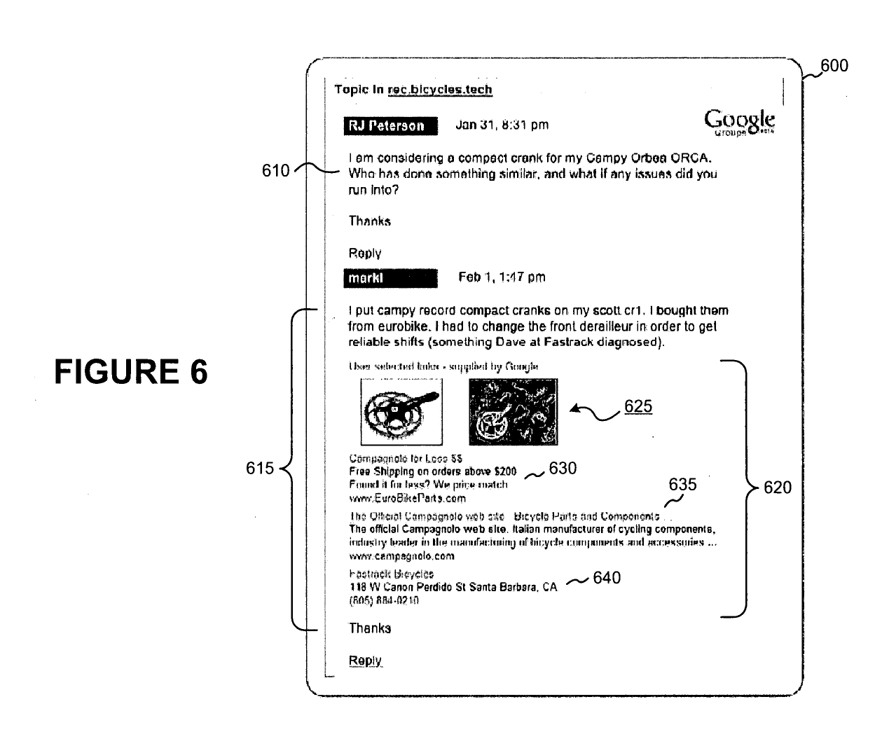

FIG. 7 is an exemplary interface 700 for applying UDA to an instant messaging (“IM”) conversation in a manner consistent with the present invention. Instant messaging can generally be defined as the act of instantly communicating (often via text, abbreviated text, or voice) between two or more people over a network, such as the Internet for example. The exemplary instant messaging interface 700 is presented to a user. This may be done by a local content creation component (e.g., an IM client) executed by a client device. (Recall, e.g., FIG. 4.) The exemplary instant messaging interface 700 includes a message display portion 710 through which transmitted instant messages are displayed, a messaging area 720 in which users may enter messages for transmission, and a UDA workspace interface 730. In this example, the two users participating in the conversation (Mark and Cindy) are discussing possible vineyards to visit. Through UDA, each user has selectively augmented their messages with results (e.g., images, search results, local search results, ads, local ads) relating to the particular vineyard under discussion. In this manner, UDA workspace interface 730 can enhance the quality of the IM conversation by, for example, allowing users to both search from within IM interface 700 and easily share selected results with other users.

In the exemplary workspace interface 700, the results might have been generated from an entered search query. Alternatively, or in addition, the results might be have been generated using an analysis (e.g., a contextual analysis such as that used by the AdSense system of Google) of one or more of the messages 710 and/or information entered in message area 720.

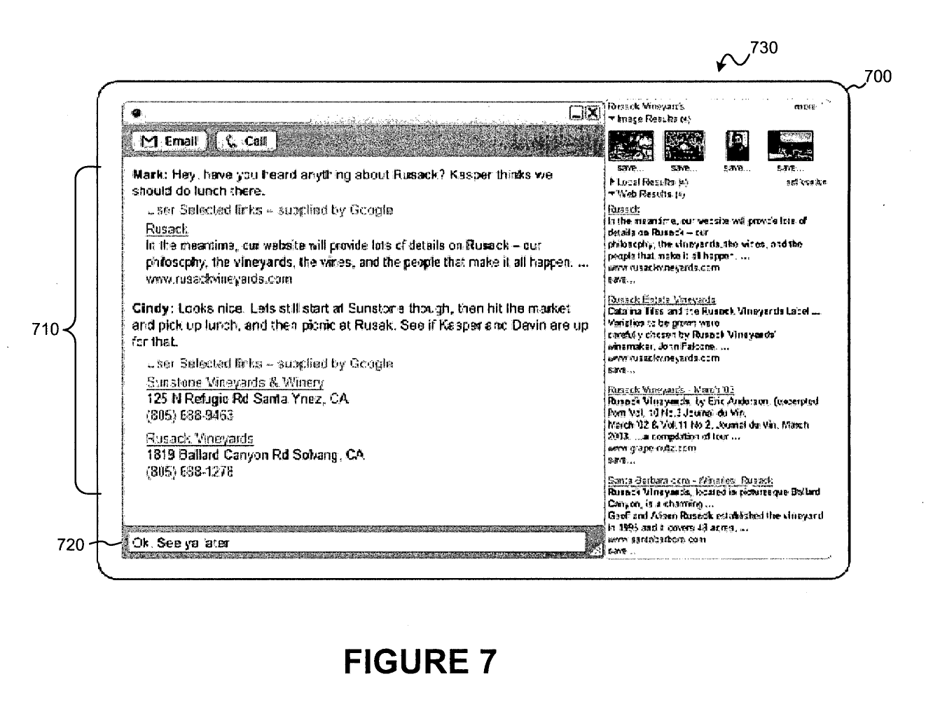

FIG. 8 is an exemplary interface 800 for applying UDA to a blog authoring tool in a manner consistent with the present invention. A blog (an abbreviated form of“Weblog ” or “Web log”) is a Website in which items are posted (e.g., on a regular basis) and generally displayed in reverse chronological order. The exemplary interface 800 of a blog authoring tool is presented to a user. This may be done by a Web-based content creation component or a locally executed blog authoring tool implemented by local content creation component. (Recall, e.g., FIG. 4.) The exemplary interface 800 may include a blog authoring section 810 in which a user (also referred to as a “blogger”) may enter and edit blog posts. UDA workspace interface 820 allows the blogger to enter search queries and receive search results in a manner similar to UDA workspace 510 of FIG. 5A. Results (e.g., search results, images, ads, local search results, local ads, etc.) inserted by the blogger may be displayed in result section 830 of the exemplary interface 800. When the blogger is ready to publish the post, he or she may select the “publish post” button 840. This selection might cause the text entered by the blogger in section 810 and any results inserted by the blogger in result section 810 to both be published as a single blog post to the blogger's blog.

§ 4.5 Conclusions

As can be appreciated from the foregoing, embodiments consistent with the present invention advantageously provide a scalable advertising platform that achieves at least some of the benefits of manual targeting. These advantages can be enhanced by assessing charges to advertisers and/or providing rewards to users who insert useful ads into documents to be distributed. Performance metrics of such ads may be generated, and information needed to generate such performance information may be tracked. Such performance metrics have many advantageous uses, as described above. Finally, user interfaces which enable advertisers to participate in a system for manual insertion of ads into a document for distribution are provided.

What is claimed is:

1. A computer-implemented method comprising:
a) rendering a set of one or more ads to a first user, wherein each of the one or more ads includes a user selectable insertion element;
b) accepting a selection input from the first user on the user selectable insertion element of one of the one or more ads; and
c) providing an instance of the one ad in a document.

2. The computer-implemented method of claim 1 further comprising:
d) accepting an input from the first user for making the document available to a second user.

3. The computer-implemented method of claim 2 wherein the act of making the document available to the second user includes transmitting the document to the second user or distributing the document to a set of users including the second user.

4. The computer-implemented method of claim 2 wherein the act of making the document available to the second user includes publishing or posting the document such that it can be accessed by the second user.

5. The computer-implemented method of claim 1 wherein the act of rendering the set of one or more ads to the first user includes providing the set of one or more ads in a workspace provided in a document authoring application.

6. The computer-implemented method of claim 1 wherein the user selectable insertion element is a graphical button element.

7. The computer-implemented method of claim 6 wherein the graphical button element is associated with executable code for inserting an instance of the ad into the document.

8. The computer-implemented method of claim 1 wherein the user selectable insertion element is a textual element.

9. The computer-implemented method of claim 8 wherein the textual element is associated with executable code for inserting an instance of the ad into the document.

10. The computer-implemented method of claim 1 wherein the accepted selection input is a user pointer-click.

11. The computer-implemented method of claim 1 wherein the document is an email message.

12. The computer-implemented method of claim 11 further comprising:
d) accepting an input from the first user for sending the email message to a second user.

13. The computer-implemented method of claim 1 wherein the document is one of (A) a blog message and (B) a message board post.

14. The computer-implemented method of claim 1 3 further comprising:
d) accepting an input from the first user for posting the one of the (A) blog message and (B) message board post, such that it is available to a second user.

15. The computer-implemented method of claim 1 wherein the document is an instant message.

16. The computer-implemented method of claim 13 further comprising: d) accepting an input from the first user for sending the instant message to a second user.

17. Apparatus comprising:
a) means for rendering a set of one or more ads to a first user, wherein each of the one or more ads includes a user selectable insertion element;
b) means for accepting a selection input from the first user on the user selectable insertion element of one of the one or more ads; and
c) means for providing an instance of the one ad in a document.

18. The apparatus of claim 17 further comprising:
d) means for accepting an input from the first user for making the document available to a second user.

19. The apparatus of claim 17 wherein the means for rendering the set of one or more ads to the first user include means for providing the set of one or more ads in a workspace provided in a document authoring application.

20. The apparatus of claim 17 wherein the user selectable insertion element is a graphical button element.

21. The apparatus of claim 20 wherein the graphical button element is associated with executable code for inserting an instance of the ad into the document.

22. The apparatus of claim 17 wherein the user selectable insertion element is a textual element.

23. The apparatus of claim 22 wherein the textual element is associated with executable code for inserting an instance of the ad into the document.

24. The apparatus of claim 17 wherein the accepted selection input is a user pointer-click.

25. The apparatus of claim 17 wherein the document is an email message.

26. The apparatus of claim 25 further comprising:
d) means for accepting an input from the first user for sending the email message to a second user.

27. The apparatus of claim 17 wherein the document is one of (A) a blog message and (B) a message board post.

28. The apparatus of claim 27 further comprising:
d) means for accepting an input from the first user for posting the one of the (A) blog message and (B) message board post, such that it is available to a second user.

29. The apparatus of claim 17 wherein the document is an instant message.

30. The apparatus of claim 29 further comprising:
d) means for accepting an input from the first user for sending the instant message to a second user.
